(19) United States
(12) Patent Application Publication
(10) Pub. No.: US 2022/0127165 A1
(43) Pub. Date: Apr. 28, 2022

(54) BRINE MANAGEMENT SYSTEM FOR ACHIEVING ZERO LIQUID DISCHARGE

(71) Applicant: Northwestern University, Evanston, IL (US)

(72) Inventors: Youhua Jiang, Chicago, IL (US); Neelesh A. Patankar, Buffalo Grove, IL (US); Kyoo-Chul Park, Wilmette, IL (US); Christian John Machado, Evanston, IL (US)

(21) Appl. No.: 17/284,890

(22) PCT Filed: Oct. 16, 2019
(86) PCT No.: PCT/US19/56463

§ 371 Date: Apr. 13, 2021

Related U.S. Application Data
(60) Provisional application No. 62/833,885, filed on Apr. 15, 2019.
(60) Provisional application No. 62/746,652, filed on Oct. 17, 2018.

(51) Int. Cl. C02F 1/12; C02F 1/14

(52) U.S. Cl. CPC C02F 1/12; C02F 2101/30; C02F 1/14

(57) ABSTRACT

Methods, apparatus, and systems for removing salt from brine are provided. A surfactant is mixed with the brines and the brines are atomized to form airborne brine droplets from which the liquid component can be rapidly evaporated. The remaining airborne salt particles are than filtered from the air stream and the water vapor condensed for collection and downstream use or processing.

### CROSS-REFERENCE TO RELATED APPLICATIONS

The present application claims priority to U.S. provisional patent application No. 62/746,652 that was filed on Oct. 17, 2018 and to U.S. provisional patent application 62/833,885 that was filed on Apr. 15, 2019, the entire contents of both of which are incorporated herein by reference.

### BACKGROUND

When the brine from desalination plants is discharged back to the sea, it destroys the ecosystem due to its higher salinity, relative to that of sea water. This environmental problem influences the economics and policies of nearby regions. For these reasons, desalination plants and governments seek a breakthrough way to treat the brine. Several methods have been tested. For example, brine has been mixed with river or ground water to reduce its salinity; however, this approach requires another water source. Alternatively, brine has been evaporated from evaporation ponds (sometimes using a structure that brine flows down or a sprayer producing raindrop like millimeter scale droplets) by sunlight; however, this process is slow and the increased salinity of the brine makes the process even slower due to the brine's high surface tension. Finally, brine has simply been heated to its boiling point in multistage flash desalination plants; however, boiling brine requires a tremendous amount of thermal energy.

### SUMMARY

Methods for separating salt from brine are provided. One embodiment of a method for separating salt from brine includes the steps of atomizing the brine solution comprising a surfactant to form airborne brine droplets; exposing the airborne brine droplets to solar radiation that vaporizes water in the brine droplets, leaving airborne salt particles; capturing the airborne salt particles; and condensing and collecting the vaporized water.

The addition of a small amount of surfactant, typically an amount that is lower than critical micellar concentration, improves the brine fog generation rate, leading to faster evaporation of brine. In addition, the evaporation of water from the liquid droplets under concentrated sunlight is increased by using atomized brine droplets having a microscale radius of curvature of brine fog droplets under concentrated sunlight and the room temperature (˜23° C.) condensation of water vapor that is heated by the concentrated sunlight can be enhanced.

The methods can be used to separate salts from brine produced by water desalination plants and other sources and can achieve near-zero, or even zero, liquid discharge by evaporating brine. Moreover, this technology enables the size of brine management systems incorporating the technology to be easily reduced for decentralized desalination systems. The methods can be carried out on brines having a wide range of salinity values, including near-zero salinity up to salinity values equal to that by the maximum solubility of sodium chloride in water.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1. Schematic of a brine management system composed of four parts: (1) atomizer, (2) evaporator, (3) filter, and (4) condenser.

FIG. 2 is a schematic diagram of a wire filtering airborne salt particles from a flowing air stream.

FIG. 3A-3D show embodiments of the superomniphilic surfaces that have a tubular geometry. In FIG. 3A, the wires are non-elastic (rigid) and have an angle of >90° with respect to the interior surface of the tube. In FIG. 3B, the wires are mechanically flexible. Initially, they form an angle of 90° with respect to the interior surface of the tube, but when a flow of air commences they undergo an elastic deformation along the direction of air flow. FIG. 3C and FIG. 3D show cross-sectional views of a plurality of the tubes arranged in a honeycomb configuration within a tubular housing. The tubes in FIG. 3C have a circular cross-section. The tubes in FIG. 3D have a hexagonal cross-section.

FIG. 4. Ultrasonic atomization rate of brine as a function of salinity.

FIG. 5. Ultrasonic atomization rate of brine as a function of salinity, with and without a surfactant.

FIG. 6. Atomization rate of brine via jet nebulization as a function of salinity.

### DETAILED DESCRIPTION

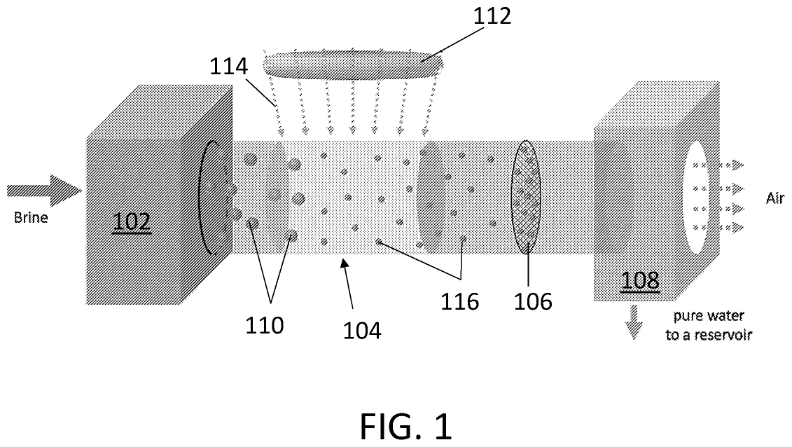

Methods, apparatus, and systems for separating salt from brine are provided. One embodiment of an apparatus that can be used to carry out a method of separating salt from brine is shown schematically in FIG. 1. The apparatus includes an atomizer 102, an evaporator chamber 104 downstream of atomizer 102, a particle filter 106 downstream of evaporator chamber 104, and a condenser 108 downstream of particle filter 106. For the purposes of this disclosure, one component can be considered downstream from an upstream component if that component is connected to and/or positioned with respect to the upstream component such that a flow of atomized brine from the upstream component flows into the downstream component. The components of the apparatus can be connected by various conduits, such as tubes and pipes.

One or more surfactants are added to the brine in order to decrease the surface tension of the brine and increase the rate at which the brine is atomized, leading to faster evaporation of brine by the methods and systems described herein. The surfactants are molecules that concentrate at the interfaces of the atomized brine droplets and air to reduce the surface tension of the brine, relative to its surface tension in the absence of the surfactants. There are a limited number of surfactants that can be used due to the compatibility between ionic salts and surfactants. In particular, anionic surfactants, such as Sodium Dodecyl Sulfate (SDS), Ammonium Dodecyl Sulfate (ADS), and Sodium Dodecylbenzenesulfonate (SDBS), are not compatible with brine. This is due to coacervation, where the long-chained surfactant creates a micelle around the cation, resulting in a precipitate. Organic cationic surfactants, however, are compatible with brine solutions, including seawater brine. This class of surfactants includes quaternary ammonium surfactants, such as cetrimonium bromide (CTAB) and cetrimonium chloride (CTAC). The suitability of a given nonionic surfactant will depend on its compatibility with the anion component of the added salt (e.g., in the case of NaCl salt, the anion). In the presence of a nonionic surfactant and an ionic salt, the internal pressure of the resultant solution increases, thereby decreasing the required surfactant concentration for micelle agglomeration to occur (this point is known as the cloud point). The compatibility of nonionic surfactants thus depends on the cloud point concentration in electrolytic solutions in comparison to the concentrations required to achieve the desired surface tension minimization. By way of illustration, Tween 80 works, but Triton-X-100 and Silwet L-77 produce clouding at the desired concentrations. If the condensed water obtained from the atomized brine will be used for consumption (i.e., as drinking water), non-toxic surfactants should be used. For example, edible surfactants that are considered Generally Recognized as Safe (GRAS) by the United States Food & Drug Administration can be used. To satisfy this requirement, plausible surfactants must be free of toxic functional groups, including, but not limited to: benzene rings, silanes, halogens, and amines. Phospholipids are biologic surfactants that both decrease the surface tension of the resulting solution and are safe for human consumption. Examples of such include, but are not limited to, phosphatidylcholine, phosphatidylglycerol, and phosphatidylserine. The surfactant concentration in the brine can be, for example, in the range from 0.05 millimolar (mM) to 2 mM. However, concentrations outside of this range can also be used. In various embodiments, the surfactant concentration is sufficient to reduce the surface tension of the brine by at least 20%, at least 25%, or at least 30%, as measured at 23° C. by the pendant drop method.

In addition to, or as an alternative to, the surfactants, a viscosity modifying polymer can be added to the brine solution in order to improve atomization. In addition to surfactants, viscosity modifying polymers can be used to adjust the brine atomization rate. Viscosity modifying polymers are long chain organic polymers whose chains extend in the presence of water. Examples of a viscosity modifying polymers are cellulose derivatives, such as methylcellulose (MC), xanthan gum, and alginates, such as sodium alginate.

The methods described herein are used to treat bulk liquid brine, where brine generally refers to an aqueous salt solution. Various salts may be present in the brines, and a brine may include a mixture of two or more different salts. One application for the methods is the removal of sodium chloride and/or other salts from water obtained from natural bodies of water, such as sea water (including ocean water), lake water, or river water. In particular, the methods can be used to remove salt from brines that are produced as a by-product of the desalination of salt water from natural bodies of water or produced by hydraulic fracturing, or for the purification of industrial, municipal, or agricultural wastewater. However, the methods are not limited to the removal of sodium chloride salt; other inorganic salts, including other halide salts as well as organic salts, can be removed. The salt concentration (salinity) in the brine can range from near zero to very high. By way of illustration, brines having a salt concentration in the range from 0.05 weight percent (wt %) to 0.3 wt %, with corresponding molarities in the range from about 1.3 to about 6, an be treated using the present methods. This includes brines having a salt concentration in the range from 0.1 wt % to 0.25 wt %, with corresponding molarities in the range from about 2 to about 5. However, brines with salt concentrations outside of these ranges can also be treated.

In an initial step of the process, a bulk liquid brine containing a surfactant is fed into atomizer 102, which breaks it up into fine airborne brine droplets 110, also referred to as a brine fog. The resulting droplets are microscale spherical droplets with diameters ranging from about 1 to about 10 μm. The brine is atomized in order to accelerate the evaporation process because evaporation of the liquid (e.g., water) from smaller droplets thermodynamically requires less energy, according to the Kelvin equation. Various types of atomizers can be used, including ultrasonic atomizers, jet nebulizers, and mesh nebulizers. From the atomizer, airborne brine droplets flow into evaporation chamber 104 wherein they are irradiated by radiation 114, typically solar radiation, which heats the droplets causing the evaporation of the liquid component (e.g., water). The evaporation chamber may have a variety of shapes and sizes provided that at least a portion of the chamber well is transparent to the radiation being used to evaporate the liquid from the droplets. Optionally, a solar concentrator 112 that includes one or more lenses, such as Fresnel lenses, concentrate and direct the radiation onto evaporation chamber 104. Optionally, fans (not shown) may be used to propel the airborne droplets from atomizer 102 into evaporation chamber 104. The evaporation of the liquid from droplets 110 leaves behind airborne salt particles 116. Salt particles 116 flow into filter 106, where they are trapped and removed from the air flow. An advantage provided by atomizing the brine is that the dry salt particles can be easily filtered in this way, whereas salt crystallization and growth on the surfaces of other brine management systems based on other methods commonly causes clogging and removal challenges. The filter may be as simple as a mesh, screen, or fabric with appropriately sized holes.

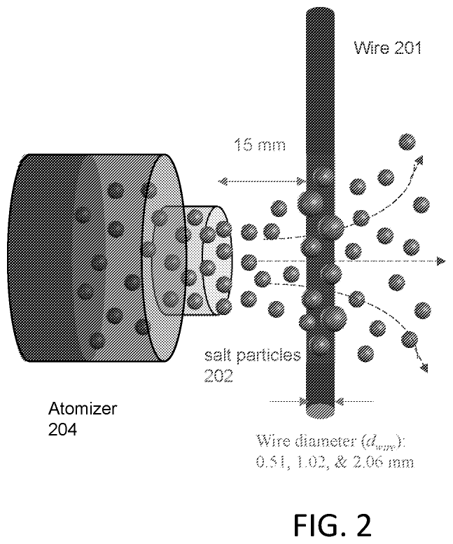

Alternatively, the filter can be composed of a wire or a plurality of wires oriented with their longitudinal axes non-parallel with the direction of air flow (e.g., oriented with their longitudinal axes oriented perpendicular with the direction of air flow. When airborne salt particles pass through the wires, at least some become stuck on the wire or in the collection of wires and are, thereby, filtered from the air. One embodiment of such a salt particle filter is shown in FIG. 2. This filter includes a wire 201, which is desirably mechanically flexible, positioned in the path of airborne salt particles 202 generated by atomizer 204. Illustrative dimensions for the wire diameter and the atomizer exit-wire distance are shown, but other dimensions can be used. Wires with smaller diameters (e.g., less than 3 mm; e.g., from 0.2 to 3 mm) lead to better salt particle collection efficiency per unit area. Flexible wires can be made from metals (e.g., aluminum) or polymers (e.g., polydimethylsiloxane). However, other materials can be used. The use of mechanically flexible wires is advantageous because the vibration and bending of flexible wires caused by the passage of the air can facilitate the transport of collected salt particles so that clogging of the filter can be prevented. A description of suited particle collection system that can be used to filter the airborne salt particles can be found in U.S. provisional application No. 62/833,885, entitled Smog Filtration Using Flexible Wires, the entire contents of which are incorporated herein by reference.

The air, which still contains the water vapor from the evaporation step, passes through filter 106 and into condenser 108, where the water vapor is condensed and passed out of the system for collection and downstream use or processing. A variety of water condensers can be used. Generally, the condenser will include at least one surface at a temperature that is sufficiently low that the vapor in the air condenses into a liquid upon contact with that surface. Suitable condenser types include air-cooled condensers and water-cooled condensers, which are widely commercially available.

Enhanced condensation can be achieved using wavy surfaces. A wavy surface geometry can enhance condensation rates compared with flat surfaces due to the focused diffusion flux on the peaks of the waves, followed by enhanced transportation of the condensed water into the valleys. The wavy surfaces may be superhydrophilic to promote fast transportation using the filmwise condensation regime. This contrasts with the standard industry practice of using dropwise condensation on flat surfaces. Therefore, this system can achieve zero liquid discharge, while obtaining purified water using solar energy. An illustrative system to condense and collect the liquid vapor includes a wavy surface formed on a substrate, where the wavy surface includes a plurality of waves defined by alternating peaks and valleys (also referred to as crests and troughs). When the water vapor generated from the atomized brine comes into contact with the wavy surface, it is condensed and accumulates in the valleys of the waves. The system may also include a liquid collection container configured to collect the liquid captured on the plurality of waves. Suitable wavy surfaces for water vapor collection are described in PCT application number PCT/US19/45682, entitled Liquid Collection on Wavy Surfaces, the entire disclosure of which is incorporated herein by reference.

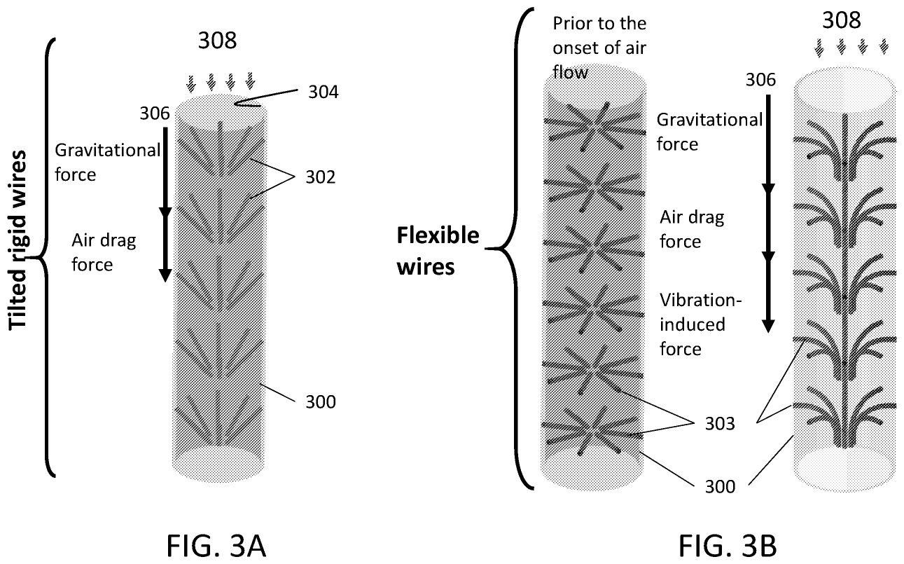

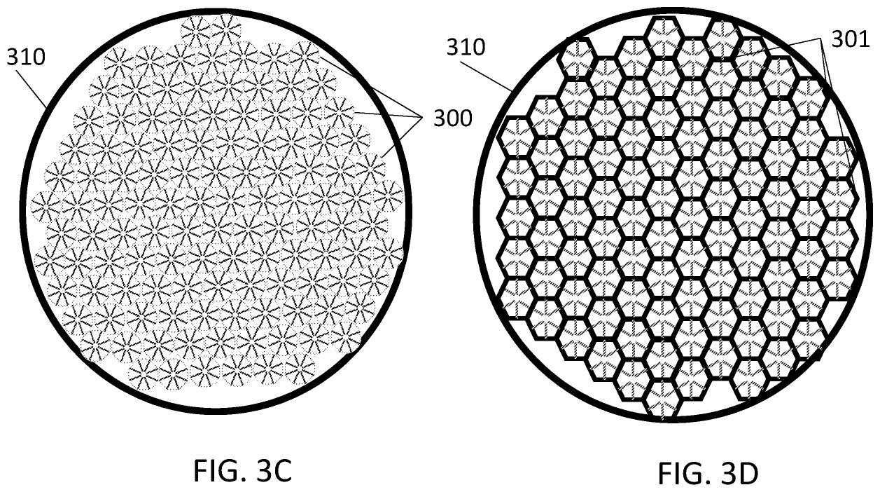

Another embodiment of a condensation system that can be used in to collect the water vapor generated from the atomized brine is shown in FIGS. 3A-3D. This system includes: a tube having an interior surface that defines an air channel; and a plurality of wires extending from the interior surface into the air channel, the wires having diameters in the range from 10 μm to 10 mm. A detailed description of condensation systems of this type is provided in PCT application number PCT/US19/15144, entitled Surfaces with High Surface Areas for Enhanced Condensation and Airborne Liquid Droplet Collection, the entire disclosure of which is incorporated herein by reference. When the air containing the water vapor passes through the air channel, it condenses as liquid droplets on the wires and the captured liquid drains away from the wires and is collected in the air channel

Some embodiments of the surfaces of the condensation system are superomniphilic. For the purposes of this disclosure, a superomniphilic surface is a surface that provides a contact angle of 5° or less for water. The system includes a support surface for a plurality of superomniphilic structures, illustrated here as superomniphilic wires 302, 303, extending into a tube 300 having an interior surface 204 that defines an air channel A plurality of superomniphilic wires 302, 303 extends away from the interior surface 204 and into the air channel Although the tubes 300 in FIGS. 3A-3C have circular cross-sectional diameters, the tubes can have other cross-sectional shapes, including, for example, square, triangular, and hexagonal (FIG. 3D). FIGS. 3C and 3D show cross-sectional views of arrays containing a plurality of the tubes 200 arranged in a honeycomb configuration within a tubular housing 310. In FIG. 3C, the tubes have a circular cross-section. In FIG. 3D, the tubes 301 have a hexagonal cross-section for increased packing density. In the embodiment shown in FIG. 3A, the wires 302 are rigid and angled along the direction of air flow 306. In the embodiment of FIG. 3B, the wires 303 are mechanically flexible. The diameter (width) of the wires affects the efficiency of liquid droplet harvesting. Thus, the wires desirably have diameters in the range from 10 [m to 10 mm. The wires may be sufficiently long to reach the center of the air channel, that is—to reach the longitudinal axis running through the center of the tube. However, in some embodiments the wires do not extend to the center of the air channel, and in some embodiments the wires are long enough to extend beyond the center of the air channel That is, the wires may have lengths that are equal to, shorter than, or longer than the internal diameter of the tube. The wires may extend outwardly from the interior surface at a 90° angle. However, they may also extend away from the interior surface at angles greater than or less than 90°. For the purposes of measuring the angle of the wires, 0° would correspond to a wire lying flat on the interior surface with it distal (i.e., free) end directed toward the entrance aperture of the tube and 180° would correspond to a wire lying flat on the interior surface with its distal end directed toward the exit aperture of the tube. In some embodiments of the tubular constructs, the wires are arranged at an angle of at least 100° with respect to the interior surface. This includes embodiment of the tubular structures in which the wires are arranged at an angle of at least 120° with respect to the interior surface. By way of illustration, the wires may be arranged at an angle in the range from 110° to 160°. The use of such angled wires is advantageous because it facilitates the draining of the liquid from the wires under the air drag force.

As shown in FIG. 3B, the wires may be mechanically flexible, such that the force of air containing the water vapor 308 flowing through the air channel causes the wires, which may initially have a vertical orientation (left panel), to undergo an elastic deformation (i.e., to bend reversibly) along the direction of the air flow (right panel). This is advantageous because elastic deformation can assist in the draining of the collected liquid from the wires. Polymeric wires, such as polyethylene, polytetrafluoroethylene, or polydimethylsiloxane wires, can be used as mechanically flexible wires. However, the particular wire material chosen will depend, at least in part, on the liquid being collected.

The tubes desirably have sufficiently large internal diameters to allow for the passage of a substantial air flow. By way of illustration, some embodiments of the tubes have an internal diameter of at least 50 μm. This includes tubes having internal diameters in the range from 50 μm to 500 mm and further includes tubes having internal diameters in the range from 10 mm to 500 mm and from 50 mm to 500 mm. The tube can be oriented with its longitudinal axes aligned with the direction of air flow. The air flow and the tube are desirably angled downward, that is—tilted downward with their exit apertures lower than their entrance apertures, such that liquid draining from the wires and collected in the air channel will flow out of the tube under the force of gravity and into a collection reservoir.

### EXAMPLE

This example demonstrates that brines with systematically varying concentrations of salt and surfactants can be atomized and further demonstrates the effects of salinity and surfactants on the rate of fog generation. To produce the brine solutions, varying masses of sodium chloride salt were added to 100 mL of deionized water. To assist in the solvation of the salt, sonication was used. To produce brine with CTAB, 0.7 mM CTAB solutions were prepared by dissolving 0.7 millimoles of CTAB to 1 L of deionized water. Sonication was used to aid in the solvation of the surfactant. Then, varying masses of the salt were added to 100 mL of 0.7 mM CTAB solution. To produce brine with methylcellulose (MC), bulk solutions of 1 w/w % MC and 2 w/w % MC were first prepared by dissolving 10 and 20 grams of MC into 1 kg of water, respectively. Gently heating and magnetically stirring the solution assisted solvation of the polymer. To produce brine with MC, varying masses of the salt were added to 100 mL of MC solution. It should be noted that the MC solutions reduced the solubility of the salt, so 0-8 w/w % brine solutions were tested, rather than 0-33 w/w %.

Six aqueous salt solution were studied, and pure water was used as a comparative example. The amount of sodium chloride added to each sample, the resulting salt concentration, and the molarity for each sample are shown in Table 1.

TABLE 1

| | | Salt | Salt | Salt | Salt | Salt | Salt |
|---|---|---|---|---|---|---|---|
| | | Solut- | Solut- | Solut- | Solut- | Solut- | Solut- |
| | Pure | ion | ion | ion | ion | ion | ion |
| | Water | 1 | 2 | 3 | 4 | 5 | 6 |
| Grams of | 0 | 40 | 80 | 120 | 200 | 280 | 330 |
| Salt per | | | | | | | |
| Kg of | | | | | | | |
| Water | | | | | | | |
| Salt | 0 | 0.04 | 0.07 | 0.11 | 0.17 | 0.22 | 0.25 |
| Concen- | | | | | | | |
| tration | | | | | | | |
| Molarity | 0 | 0.68 | 1.34 | 2.00 | 3.28 | 4.61 | 5.47 |

The fog-generation (i.e., atomization) rate was calculated by measuring the decrease in brine mass on a microbalance. At a fixed atomization condition, the results show that the rate of fog generation decreased with an increase in the brine salinity. With the addition of surfactants to the brine, the fog generation rate was enhanced, while the addition of the MC viscosity modifying polymers reduced the fog generation rate. The physio-chemical properties of the brine, such as surface tension and dynamic viscosity, were found to be factors that determine the generation rate. These brine fog droplets can be completely evaporated using concentrated solar energy, and the airborne salt microparticles remaining after the evaporation of the liquid from the droplets can be captured using a filter, through which the atomized droplets pass. The high temperature water vapor passing through the filters can be recaptured by room temperature condensation.

The apparatus used to separate the salt from the water of a brine is shown schematically in FIG. 1, as previously described. Brine from a desalination system was atomized by ultrasonic, jet, or/and mesh nebulization method(s) for more efficient evaporation. The brine fog droplets resulting from the atomization were then flowed through a high temperature evaporation section (e.g., a tube) that was heated by concentrated solar energy using Fresnel lenses to create a high temperature environment. The remaining dry salt particles were then captured by a filter system, while pure water was collected as the hot water vapor passed through a low-temperature condensation system that was cooled by natural/forced convection.

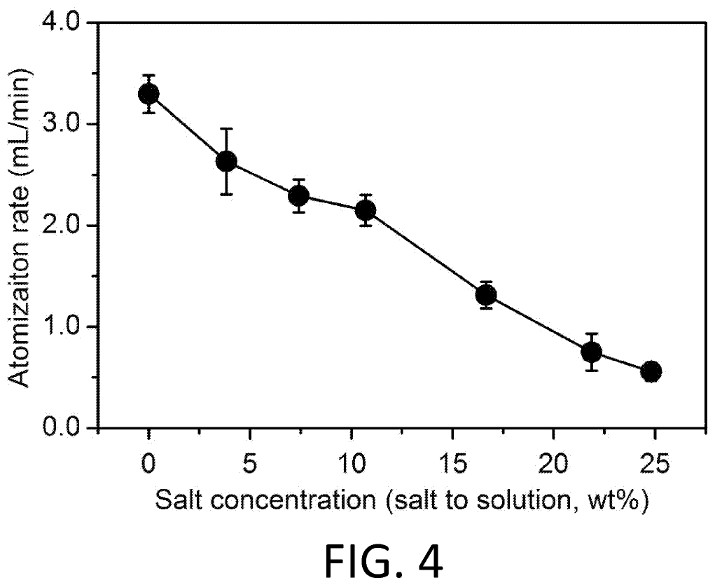

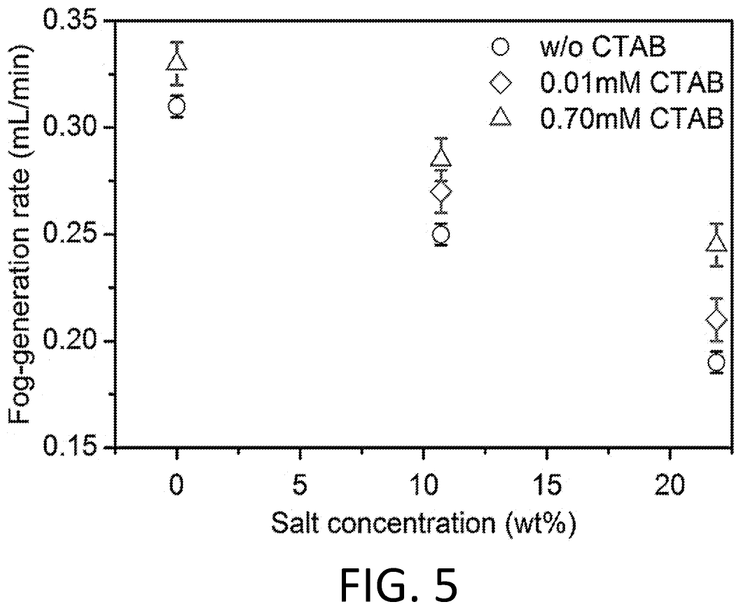

The use of atomization to produce airborne micrometer scale brine droplets using different atomization methods (ultrasonication and jet nebulization) even for the highest salinity solution is demonstrated in FIG. 4 and in FIG. 5. FIG. 4 shows the ultrasonic atomization rate that was used for brine samples having different salt concentrations without a surfactant. As shown in the graphs, the atomization rate monotonically decreased as the salt concentration (in weight percent, wt %) increased.

FIG. 5 shows the atomization rate that was used for brine samples having different salt concentrations using jet nebulization at ˜5 psi and different concentrations of CTAB. In contrast to the ultrasonic atomization of brine, the decrease in the fog generation rate at the maximum salt concentrate was limited to nearly half of the maximum fog generation when salinity=0%, i.e. pure water. Moreover, the addition of the surfactant increased the fog generation rate for each brine sample by ˜30-40%, likely due to the significant reduction of surface tension of the brine when a small amount of the surfactant (e.g., 0.7 mM) was dissolved therein. Table 2 reports the surface tensions of the brine samples at room temperature, as measured by the pendent drop method.

TABLE 2
Surface Tension (mN/m)

| Salt Concentration | Without | With 0.7 mM |
|---|---|---|
| (w/w %) | CTAB | CTAB |
| 0 | 72.41 | 39.38 |
| 0.4 | 74.71 | 36.56 |
| 0.7 | 75.82 | 35.60 |
| 0.11 | 80.62 | 35.76 |
| 0.17 | 82.37 | 42.48 |
| 0.22 | 85.75 | 58.43 |
| 0.25 | 87.93 | 61.6 |

These results demonstrate that adding surfactant to the brine can save a tremendous amount of thermal/solar thermal energy.

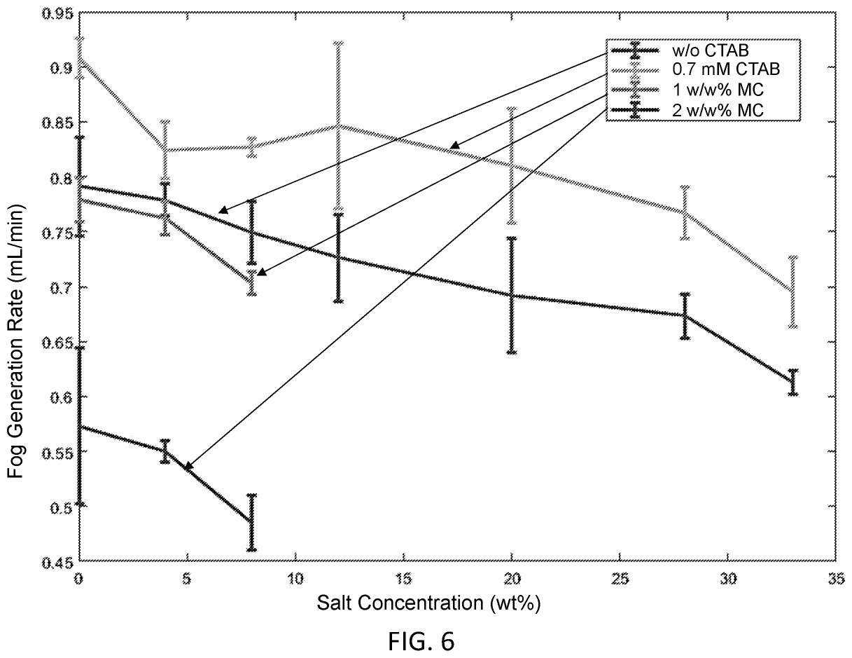

FIG. 6 shows the atomization rate of various brine solutions using jet nebulization at 30 psi. Brine solutions containing 0.7 mM CTAB, 1 w/w % MC, and 2 w/w % MC were tested. Table 3 reports the viscosities of the varying MC solutions tested, as tested by the manufacturer (Acros Organics). As shown in FIG. 6, surfactant enhancement remains valid even at high pressure atomization. Additionally, a strong correlation between dynamic viscosity and brine generation rate has been empirically shown. Reducing the concentration of MC from 2 w/w % to 0 w/w % reduced the dynamic viscosity of the solution from ˜15 cp to ˜1 cp. This reduction in dynamic viscosity resulted in a ˜30-40% increase in the atomization rate. While MC would not be present in brine, the presence of MC in this Example demonstrates that reducing the dynamic viscosity of the brine solution enhances the atomization rate of the brine. There exists a significant temperature dependence on the dynamic viscosity of solutions, whereas higher temperatures result in reduced viscosities. Therefore, preheating the brine solution to below the boiling point will reduce its dynamic viscosity, and, thus, increase its potential atomization rate.

TABLE 3
Dynamic Viscosity (cp)

| Pure Water | 1 w/w % Methylcellulose | 2 w/w % Methylcellulose |
|---|---|---|
| 1 | 8 | 15 |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A method for separating salt from a brine comprising salt, water, and a surfactant, the method comprising:
atomizing the brine to form airborne brine droplets;
exposing the airborne brine droplets to radiation that vaporizes water in the brine droplets, leaving airborne salt particles;
filtering the airborne salt particles from the air; and
condensing and collecting the vaporized water.

2. The method of claim 1, wherein the surfactant is a cationic surfactant.

3. The method of claim 1, wherein the surfactant is an edible surfactant.

4. The method of claim 1, wherein the surfactant is a phospholipid surfactant.

5. The method of claim 1, wherein the radiation is solar radiation.

6. The method of claim 1, wherein the brine is a produced in a water desalination plant.

7. The method of claim 6, wherein the water desalination plant is a seawater desalination plant.

8. The method of claim 1, wherein the brine has a salt concentration in the range from 0.05 to 3 weight percent.

9. The method of claim 1, wherein the brine has a surfactant concentration in the range from 0.1 to 1 mM.

10. The method of claim 1, wherein atomizing the brine is carried out using a jet nebulizer.

11. The method of claim 1, wherein the brine droplets have diameters in the range from 1 μm to 10 μm.

12. The method of claim 1, wherein filtering the airborne salt particles from the air comprises passing the airborne salt particles over a plurality of wires to which the salt particles adhere.

13. The method of claim 1, wherein collecting and condensing the vaporized water comprises passing the vaporized water over a wavy surface on which the vaporized water condenses.
